(19) United States
(12) Patent Application Publication
(10) Pub. No.: US 2021/0119932 A1
(43) Pub. Date: Apr. 22, 2021

(54) GEOGRAPHICAL ACCOUNT LOCKING SYSTEM AND METHOD

(71) Applicant: Saudi Arabian Oil Company, Dhahran (SA)

(72) Inventors: Hamed A. Alshafei, Dhahran (SA); Tarik A. Bankash, Dhahran (SA); Mohamed A. Sierafi, Dhahran (SA)

(21) Appl. No.: 16/656,095

(22) Filed: Oct. 17, 2019

(51) Int. Cl. H04L 12/911; H04L 12/917; G06N 7/00; G06F 16/29; G06F 16/25; G06F 16/28

(52) U.S. Cl. CPC H04L 47/78; H04L 47/76; H04L 47/748; G06F 16/288; G06F 16/29; G06F 16/252; G06N 7/005

(57) ABSTRACT

A computing device can be configured to receive information representing access and/or requests to access resources on at least one network. Access to a first network-based resource at a first time by a first entity is detected, and a request for access to, access to, or both the request for access and the access to a second network-based resource at a second time by the first entity is detected. A period of elapsed time between the first time and the second time is calculated and a probability of the first entity accessing or requesting access to the second network-based resource within the period of elapsed time of having accessed the first network-based resource is calculated. Thereafter, first entity's access to at least one network-based resource is regulated based on the determined probability relative to a predetermined threshold.

### FIELD OF THE DISCLOSURE

This patent application relates generally to systems and methods for network security, and, more particularly, to regulating access to respective network-based resources based on operational parameters.

### BACKGROUND OF THE DISCLOSURE

Physical security and cybersecurity are used to protect networks and physical facilities, including an organization and an organization's data, against attack, damage or unauthorized access.

Industrial security include various modules to keep large structures, such as corporate complexes, schools, and hospitals, protected from unauthorized access. For example, building and lots include keycard entrances, electronic surveillance, and communications to protect against unauthorized access. In addition, industrial security can include personnel teams, each performing respective security tasks that are centrally coordinated and connected.

Preventing unauthorized access to such networks and network-based resources is paramount to protecting the integrity of an organization and its resources (including physical locations, network sessions, information, files, objects, and intellectual property). Cybersecurity and physical security schemes have well developed mechanisms to strengthen access management and prevent unauthorized access to corporate networks and physical facilities. For example, mechanisms have been implemented to strengthen users' passwords and provide 2-step authentication.

Despite implementations to improve physical and virtual facility security, unauthorized access to physical and virtual resources remains a concern. It is with respect to this background that the present disclosure is addressed.

### SUMMARY OF THE DISCLOSURE

According to one or more implementations consistent with the present disclosure, a computer-based system and method regulates access to respective network-based resources. Thus, in one implementation, at least one computing device is configured to receive information representing access to and/or access requests to resources on at least one network. More particularly, the computing device(s) detect access to a first network-based resource at a first time by a first entity. The first network-based resource and the first entity can be represented directly or indirectly by information received by the computing device(s). Moreover, the computing device(s) detect a request for access to, access to, or both the request for access and the access to a second network-based resource at a second time by the first entity, wherein the second network-based resource and the first entity are represented directly or indirectly by information received by the computing device(s). Moreover, the computing device(s) calculate a period of elapsed time between the first time and the second time. The computing device(s) determine a probability of the first entity accessing or requesting access to the second network-based resource within the period of elapsed time of having accessed the first network-based resource. Thereafter, the computing device(s) regulate the first entity's access to at least one network-based resource based on the determined probability relative to a predetermined threshold.

In certain implementations, the system and method comprise that at least one computing device (more generally, sometimes referred to herein simply as “the computing device”) determining a distance between the first network-based resource and the second network-based resource. The computing device's determined probability further can be based on the determined distance.

In one or more implementations, the system and method comprise the computing device determining a distance from a location of accessing the first network-based resource to a location of accessing and/or requesting access to the second network-based resource. The computing device's determined probability further can be based on the determined distance.

Furthermore, in certain implementations the system and method comprise the computing device defining a plurality of geographic zones, each geographic zone comprising at least one endpoint for at least one respective network-based resource. Further, the computing device can determine a distance between the first network-based resource and the second network-based resource as a function of at least one of the respective geographic zones. The computing device's determined probability further can be based on the determined distance.

In certain implementations, regulating the first entity's access to at least one network-based resource by the computing device is based on a change in the first entity's position over time.

Moreover, in certain implementations the computing device provides information to an information security dashboard which represents the regulation of the first entity's access to at least one network-based resource. The information security dashboard can include a graphical user interface having at least one graphical control that, when selected, causes the computing device to regulate the first entity's access to at least one network-based resource.

In one or more implementations, the first network-based resource and the second network-based resource are respectively located on at least one physical and/or virtual network.

Moreover, in certain implementations accessing the first network-based resource by the first entity physically occurs by scanning an identification card, wherein accessing or requesting access to the second network-based resource by the first entity occurs by logging into a computing device physically located away from the first network-based resource.

Moreover, in certain implementations regulating the first entity's access to at least one network-based resource comprises permitting the first entity's access to at least one resource when the determined probability is inside the predetermined threshold and restricting the first entity's access to at least one resource when the determined probability is outside the predetermined threshold.

In one or more implementations, regulating the first entity's access comprises not impeding the first entity's access to at least one network-based resource.

Moreover, in one or more implementations at least one network-based resource is the second network-based resource.

In one or more implementations, the first network-based resource and the second network-based resource are separated by a distance.

Moreover, in one or more implementations regulating the first entity's access to at least one network-based resource includes downgrading access privileges.

Additional features, advantages, and embodiments of the disclosure may be set forth or apparent from consideration of the detailed description and drawings. Moreover, it is to be understood that the foregoing summary of the disclosure and the following detailed description and drawings provide non-limiting examples that are intended to provide further explanation without limiting the scope of the disclosure as claimed.

### BRIEF DESCRIPTION OF THE DRAWINGS

The accompanying drawing figures illustrate exemplary embodiments and are not intended to be limiting of the present disclosure. Among the drawing figures, like references are intended to refer to like or corresponding parts.

FIG. 1 is a flow diagram showing a routine that illustrates a broad aspect of the present application, in accordance with one or more embodiments.

FIG. 2 is a flow diagram illustrating details associated with certain steps illustrated in FIG. 1, in accordance with one or more embodiments of the present application.

FIG. 3 is a simple block diagram of an implementation of the present disclosure and illustrating a plurality of buildings respectively located within two cities.

FIG. 4 is a simple block diagram of an access point and a plurality of relative geographic zones.

FIG. 5 is a block diagram that shows an example hardware arrangement that operates for providing the systems and methods disclosed herein.

FIG. 6 shows an example of a computing device that can be used to implement the techniques described herein the present application.

### DETAILED DESCRIPTION OF CERTAIN EMBODIMENTS ACCORDING TO THE DISCLOSURE

By way of overview and introduction, the present application presents technical method(s) and system(s) for identifying and preventing security breaches, and for generating/transmitting alerts and taking corrective action. Furthermore, in one or more implementations, locking and/or preventing unauthorized access to physical and/or virtual resources is provided by at least one computing device.

The teachings herein include systems and methods to strengthen access management and prevent unauthorized entities from accessing corporate networks and physical facilities. The present disclosure further enhances security by utilizing location and distance information. Locking techniques can be used in response to information representing an entity attempting an unauthorized access to a physical facility (e.g., buildings, data centers, colleges) and/or networks. Access information from different physical locations within a period of time that would not be possible or at least highly unlikely can result in suspension of credentials and privileges.

Further, multiple location access can be tracked and used to determine that such access would be impossible by a single entity. Access privileges can be downgraded to preclude harmful actions/access as a result. Such modifications can be represented instantly in an information security dashboard, to identify, manage and respond to unauthorized activity and security threats.

For example, information representing access to and/or requests to access resources on at least one network is received by a computing device. After a first resource is accessed, a request for access to, access to, or both the request for access and the access to a second network-based resource at a second time by the first user is detected. A period of elapsed time between the first time and the second time is detected, and a probability of the first user accessing or requesting access to the second network-based resource within the period of elapsed time of having accessed the first network-based resource is determined. Thereafter, the computing device(s) regulates the first user's access to at least one network-based resource based on the determined probability relative to a predetermined threshold.

In accordance with the present disclosure, the term, “regulate,” refers generally to permitting access or precluding access to physical and/or virtual resources, depending on a determined probability being inside or outside a threshold. In one implementation, inside a threshold refers to being above a threshold value and outside refers to being below the threshold value. In an alternative implementation, within the threshold can refer to being below.

In addition, “regulating” can refer to leaving an entity's access to a resource untouched, as opposed to altering access rights. Further, a computing device can regulate an entity's access rights to one or more resources as a function of a determination of the determined probability being inside or outside a predetermined threshold, depending on a respective implementation.

Also, as used herein, an “entity” can refer to a person, a device, or a combination of a person and a device. An entity's actions in accordance with the present application can be in human form, such as a person walking through a gate. Further, an entity's actions can be in virtual form, such as an entity using a computing device that is connected to one or more data communication networks to access and/or request access to a network-based resource. An entity's actions can include controlling (or attempting to control) a device to perform some operation. For example, an entity may attempt to gain access to a networked-resource in an effort to instruct another device to disable a security function or cause some other particular malicious result.

As used herein, the term, “endpoint,” can represent any physical or virtual device on a local area network or wide area network that communicates across a network and that enables physical/virtual devices to access to the network. As used herein, an endpoint refers to a physical/virtual device that assists with connectivity to various ones of a variety of networks. In accordance with the present disclosure, such network endpoints are not limited to any particular network, such as a TCP/IP network, but can span across all networks.

Other terms are defined below.

Accordingly, the present application supports virtually any number of a plurality of endpoints and types of endpoints, which can be located virtually anywhere. For example, the first endpoint and the second endpoints can both interface with an entity's identification card, such as optically via a barcode, by radio-frequency via an RFID tag, or by other remote technique. The first endpoint and the second endpoint can be the same particular device, can be two different devices of the same type, or can be two different types of endpoints.

In one or more implementations, systems and methods of the present disclosure factor location information into the probability determination to regulate access to corporate secure facilities and corporate networks. A determination can be made, for example, reaching a respective location from another location is not possible within a given amount of time. In addition, access to one or more resources from multiple locations can be tracked and a determination can be made that such access would not be possible. A single entity's simultaneous access (or requests to access) resources from multiple locations may be impossible, which can trigger a computing device to regulate the access rights of the entity. User privileges to access the resource(s) can be adjusted automatically to preclude any harmful actions/access, and instantaneously manage and respond to security threats.

For example, an employee uses a computer to log in to a network that is associated with domain A at a given time. Domain A is defined at a location, P. Thereafter, the employee uses the same credentials (e.g., login ID and password) to attempt to login to a network associated with domain B at a given time, where domain B is defined at a location, Q. A determination is made that, given the distance between P and Q, the travel time to login in the two different locations within the particular time is not possible. More particularly, a probability can be calculated representing the likelihood of the user accessing domains A and B within the designated time period. The determined probability can be compared to a predefined threshold and, depending on a respective implementation, access control can be regulated depending on whether the probability is inside or outside of the threshold. Accordingly, corrective measures can be taken after an unauthorized entity unsuccessfully attempts to access (or successfully accesses) an organization's resource. For example, once detected, a security monitoring center can be alerted of the potential or actual intrusion and/or access to one or more resources can be blocked.

In one or more implementation, the distance between two endpoints P and Q can be calculated using: P(x1,y1) and Q(x2,y2), where d(P, Q)=sqrt (x2−x1)²+(y2−y1)². In addition, or in the alternative, the distance between two endpoints can be calculated using the haversine formula, which calculates the distance between two points on a sphere given respective latitude and longitude values. In accordance with the present application, the endpoints' respective internet protocol (“IP”) addresses can be used to determine the locations of Point A and Point B and, correspondingly, the points' respective latitude and longitude values.

Thus, the present disclosure provides systems and methods to prevent and/or detect unauthorized access to secure facilities and corporate networks, including as a function of access management. Such prevention and/or detection of unauthorized access to facilities and networks can be accomplished as a function of time and location information, as shown and described herein.

In another example, an entity physically enters a facility endpoint (“A”) at a first point in time using his/her physical identification card. Thereafter, at a second point in time, the entity attempts to access a second endpoint (“B”) from a corporate workstation or security gate located in the facility. The distance between Point A and Point B is known and/or determined, as described herein. In accordance with the present disclosure, determination(s) regarding the authenticity and/or authorization of the entity are made, including that the entity could not physically have accessed endpoint B within the time of accessing endpoint A. In response to such determinations, access to network-based resources for the entity is locked. Information protection is also supported, including by providing alerts to a Security Operations Center (SOC) dashboard to inform administrators, and to enable protective measures to be taken.

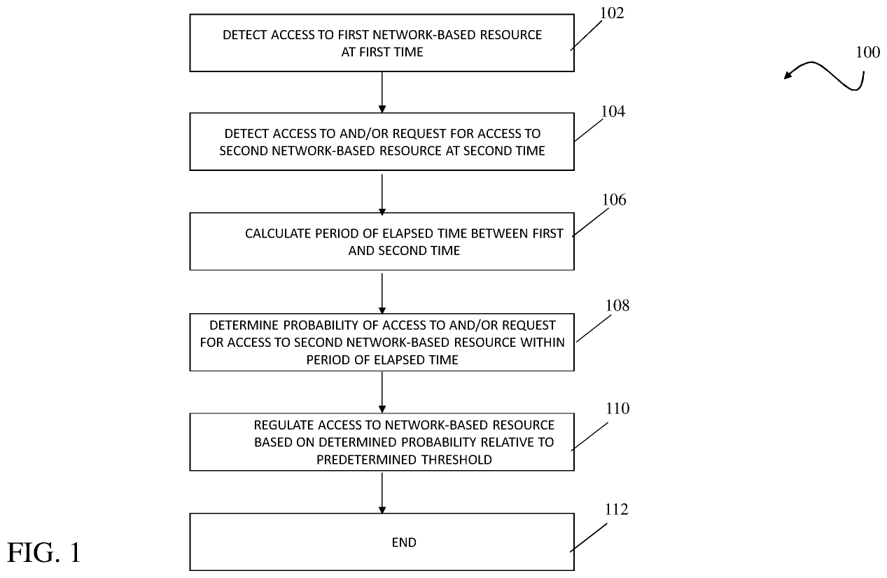

Turning now to FIG. 1, a flow diagram is described showing a routine 100 that illustrates a broad aspect of a method for regulating access to network-based resources in accordance with one or more embodiments of the present application. It is to be appreciated that several of the logical operations described herein are implemented as a sequence of computer-implemented acts or program modules running on one or more computing devices. Accordingly, the logical operations described herein are referred to variously as operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

Continuing with reference to FIG. 1, the process begins at step 102 in which access to a first network-based resource at a first time by an entity is detected by at least one computing device. Access to the first network-based resource can be of several types and methodologies. For example, access to the first network-based resource can include an entity providing an identification card to a card reader device. For example, an identification card can be equipped with radio-frequency identification (“RFID”) tag that enables an entity to “swipe” his/her identification card near a device configured with RFID reading technology. The entity's credentials can be provided to physically pass an endpoint, such as a parking lot, a building entrance, or other suitable endpoint. Alternatively, or in addition, an entity's identification card can include a barcode (e.g., an RSS barcode) that includes the entity's credentials, which can be scanned, photographed, and/or otherwise read. In addition to technology for scanning and receiving information via barcode and radio-based technology, other technologies are supported for receiving and confirming the authorization of entities who are requesting access or accessing resources. Once information associated with access and activity has been received, processes shown and described herein can be executed by a computing device configured to detect whether an entity's access to and/or requests to access network-based resources is authorized.

Continuing with reference to FIG. 1, at step 104 access to a second network-based resource (or a request for access to the second network-based resource) at a second time is detected. As noted above, access to the second network-based resource can be of a various type and method. For example, a card reader in a lobby of a building (e.g., the second network-based resource) receives information in response to the entity swiping his/her RFID-equipped/barcoded ID card operates as an endpoint for the entity to enter the building. In this example, a network-based resource includes the device and its particular location (e.g., the lobby).

Continuing with FIG. 1, at step 106, a period of elapsed time from the first time to the second time is calculated by at least one computing device, e.g., 10 seconds. At step 108, a probability of the entity accessing and/or requesting access to the second network-based resource within the period of elapsed time is determined. For example, and pursuant to a respective design implementation, a determination can be made that the determined probability of a legitimate entity accessing the second network-based resource within 10 seconds is 2%. At step 110, the entity's access to at least one network-based resource is regulated, including based on the determined probability relative to a predetermined threshold value. Continuing with the previous example, the determined probability of 2% is outside of a threshold value of 30%, thereby causing the computing device to take corrective measures.

Corrective measures can include suspending the entity's credentials to access network-based resources to fend off an attack, theft, or other unwanted and potentially dangerous unauthorized network-based activity. Other measures include reducing or otherwise affecting access privileges to network-based resources. Alternatively, if the determined probability is within the threshold value, such as above the threshold value, then the entity's access rights to network-based resources can be regulated by maintaining and not modifying the user's credentials. Other action can include resuming previously suspended access rights, increasing network access rights, and revising/removing security measures for the entity to access one or more network-based resources. At step 112 of FIG. 1, the process ends.

It will become apparent following a review of the present disclosure that virtually any known access control security infrastructure, including any that include virtually any respective protocol, is supported and improved upon by the teachings herein. Known and existing security implementations benefit by implementing the configurations of the present disclosure to detect sequential and/or simultaneous access (or requests for access) to network-based resources via endpoints over periods of time. Modules operating in connection with the teachings herein use information associated with access activity to identify with high probability whether a particular entity requesting or accessing a network-based resource has been compromised or is otherwise involved in unauthorized and potentially harmful activity.

For example, information regarding access (or requests for access) to the first and second network-based resources can be received from devices, such as ID card readers, scanners, computing devices that are physically located at particular premises, mobile computing devices (e.g., tablet computers, smartphones, and discreet IOT devices). Moreover, information regarding access to network-based resources can be received from hardware and software sources, such as network routers, firewalls, wireless networks, BLUETOOTH communications, Internet and e-mail activity, in-camera meta-data or the like. Information can be received via various communication platforms and protocols, including but not limited to extensible messaging and presence protocol (“XMPP”).

Implementations of the present disclosure can include virtually any combination of entities and endpoints. Access to example endpoints of the first and/or second network-based resources can include (without limitation) a card reader, a scanning device, a personal computer, a laptop/notebook computer, a camera, a tablet computer, a smartphone, wearable technology (e.g., smartwatches, bands, and jewelry), discreet IOT devices, or other suitable endpoint device/component. Endpoints can be identified in many different ways, such as by identifiers that are hardcoded in the devices themselves (e.g., card readers). Endpoints can also be identified by information in data transmissions.

In one example, an entity using a device connected to a local wireless network submits a request and credentials to accesses a network-based resource. Simultaneously or within a short period of time later, an entity that is connected to a different network located physically far from the local wireless network provides the same credentials previously used to access the network-based resource. Information regarding either location can be detected as a function multiple devices engaged in networked activity vis-à-vis various endpoints. Other sources of location and time information regarding the entity can include surveillance content, local camera content, GPS data, or other location data. In this example, given the distance between the two respective locations, a low probability determination that is outside (or inside, depending on a particular implementation) a predetermined threshold is made. All of the information can be processed to determine that the entity is unauthorized for the first access, the second access, or both the first and second accesses.

Accordingly, information from a plurality of sources can be received and used by at least one computing device to detect whether an entity is authorized to access one or more network-based resources.

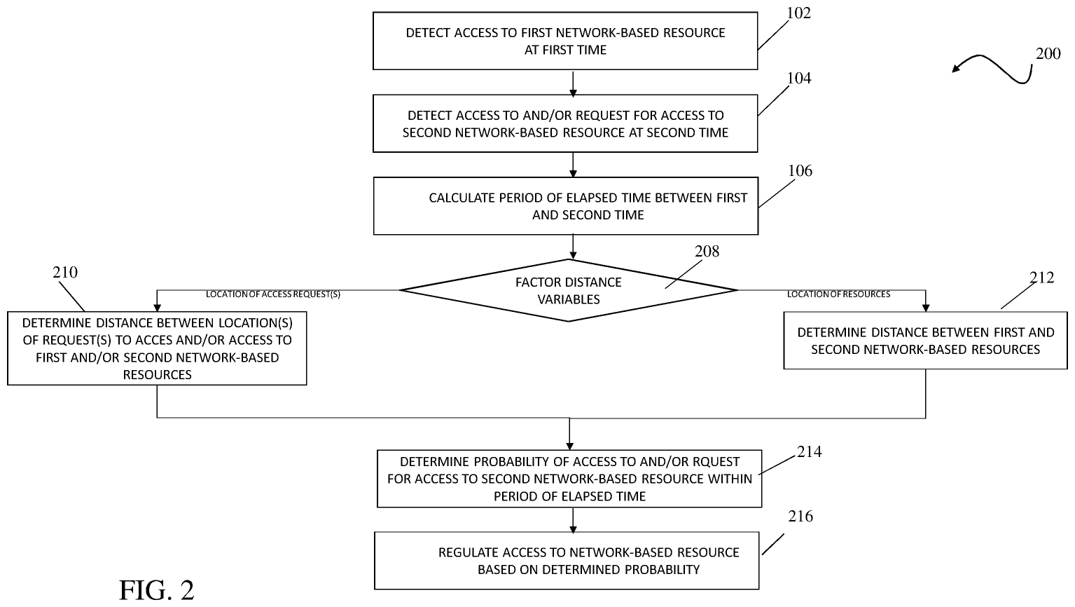

FIG. 2 is a flow diagram illustrating steps associated with features set forth in FIG. 1, as well as additional steps, in accordance with one or more implementations of the present disclosure. At step 102, access to a first network-based resource at a first time by an entity is detected by at least one computing device. At step 104 access to a second network-based resource (or a request for access to the second network-based resource) at a second time is detected by at least one computing device. At step 106, a period of elapsed time from the first time to the second time is calculated by at least one computing device.

Continuing with reference to FIG. 2, distance variables are factored at step 208. At step 210, the process branches and a determination is made of the distance between respective endpoints, such as locations of requests to access network-based resource(s) and/or points of access to network-based resource(s). At step 212, the process branches and a determination is made of the distance between the respective network-based resources. Thereafter, at step 214 a probability of the entity accessing and/or requesting access to the second network-based resource within the period of elapsed time is determined. At step 216, the entity's access to at least one network-based resource is regulated, including based on the determined probability relative to a predetermined threshold value.

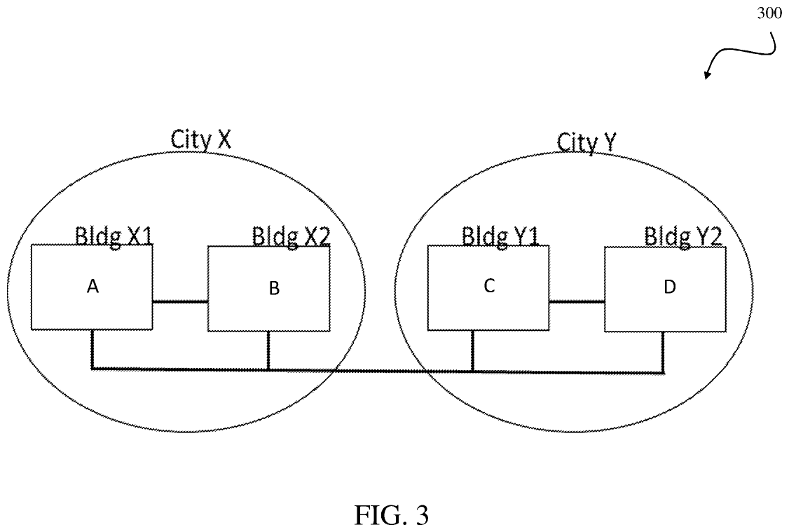

FIG. 3 is a simple block diagram of an implementation 300 of the present disclosure and illustrating a plurality of buildings respectively located within two cities (City X and City Y). For example, an employee physically enters a secure facility at Point A in city X using his/her corporate ID. Thereafter, an attempt to access an endpoint, such as a workstation or security gate, located at Point C in city Y using the employee's credentials is detected. After a determination that the distance between Point A and Point C is significant and factoring the attempt to access Point C within a short period of time, such as one minute, a probability can be determined that is below a threshold, supporting a conclusion that the access to Point C is unauthorized. Access to Point C would, therefore, be regulated to preclude access. Further, one or more entries can be provided to a security dashboard, representing a possible security threat in view of the employee could not have physically traveled the distance between the two sites within the given time.

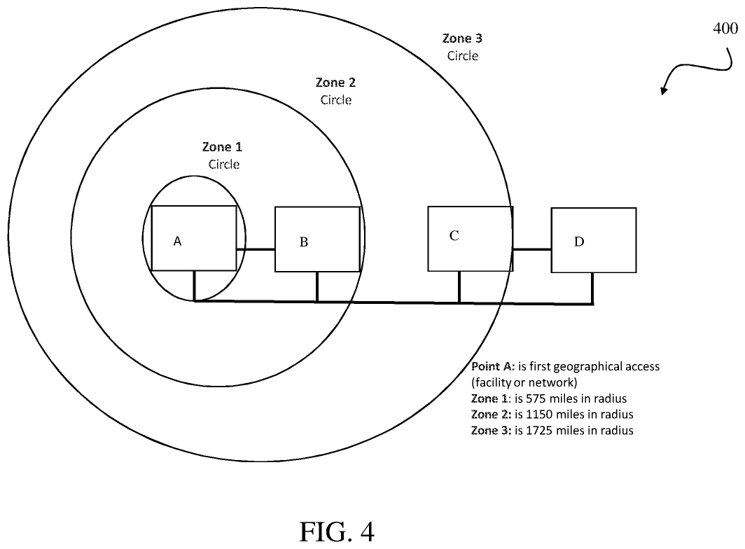

In one or more implementations of the present application, a plurality of geographic zones can be defined as a function of the amount of distance that a person can travel over time. Each geographic zone can have a respective radius and respective access endpoints and physical facilities. FIG. 4 is a simple block diagram of a plurality of geographic zones. Endpoint A represents a facility or network, which was first accessed by an entity. The present disclosure's locking mechanism can restrict an entity's facility access or network login to a set of geophysical zones, including as a function of various travel methods and speeds that are available in a region. The rate of change in position, or speed, is equal to distance traveled divided by time. Therefore, a particular user login can be restricted to either customized zones set by a proprietor of the present disclosure, or to a maximum speed, such as air travel speed. For example, air travel speed can be 575 mph, which equates to 575 miles of distance from the most recent physical access, per hour. For example, Hour 0 is the last registered physical access for an entity. Each minute provides for a maximum distance of 9.5 miles (575 miles/60 minutes) to access an endpoint (e.g., log in to a respective network) from the most recently registered physical or network access.

Continuing with reference to FIG. 4, Zone 1 is 575 miles in radius. The end of Hour 1 permits for a network login at a maximum distance of 575 miles away from the last physical or network access. Zone 2 has a radius of an additional 575 miles (1150), which would permit for network login at the end of Hour 2. Zone 3 has a radius of an additional 575 miles (1725), and so on.

As will be apparent from the foregoing, the zones can be of selected having an arbitrary size suitable for the zone to be protected and can be configured to enable a login after a period of time suitable for the protected zone and the travel method(s) encoded in the system. As such, a zone can be set within a limited number of miles, such as 20 miles, from a facility and the travel method can be computed using typical speeds permitted on roads within that radius for a car, or for other land-based transportation (bicycle, scooters, etc.).

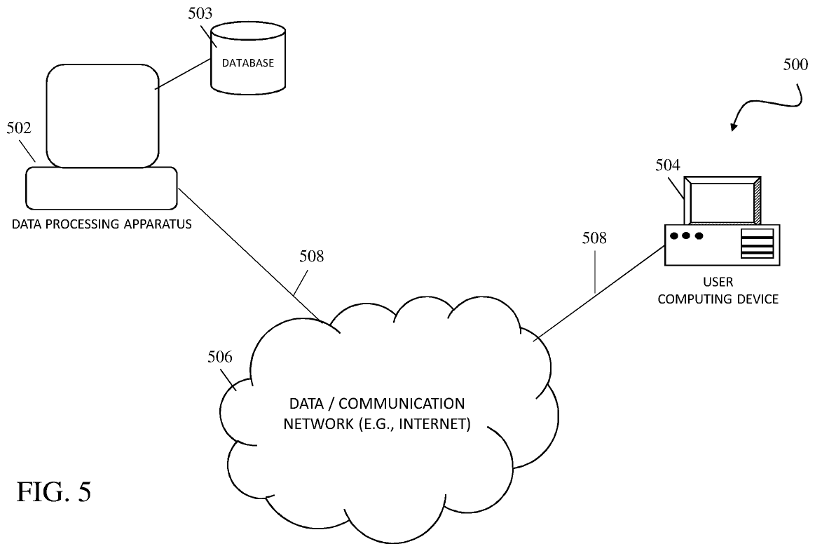

Referring to FIG. 5, a diagram is provided that shows an example hardware arrangement that operates for providing the systems and methods disclosed herein and designated generally as system 500. System 500 can include one or more information processors 502 that are at least communicatively coupled to one or more user computing devices 504 across communication network 506. Information processors 502 and user computing devices 504 can include, for example, mobile computing devices such as tablet computing devices, smartphones, personal digital assistants or the like, as well as laptop computers and/or desktop computers, server computers and mainframe computers. Further, one computing device may be configured as an information processor 502 and a user computing device 504, depending upon operations being executed at a particular time.

With continued reference to FIG. 5, information processor 502 can be configured to access one or more databases 503 for the present application, including source code repositories and other information. However, it is contemplated that information processor 502 can access any required databases via communication network 506 or any other communication network to which information processor 502 has access. Information processor 502 can communicate with devices comprising databases using any known communication method, including a direct serial, parallel, universal serial bus (“USB”) interface, or via a local or wide area network.

User computing devices 504 can communicate with information processors 502 using data connections 508, which are respectively coupled to communication network 506. Communication network 506 can be any communication network, but typically is or includes the Internet or other computer network. Data connections 508 can be any known arrangement for accessing communication network 506, such as the public internet, private Internet (e.g. VPN), dedicated Internet connection, or dial-up serial line interface protocol/point-to-point protocol (SLIPP/PPP), integrated services digital network (ISDN), dedicated leased-line service, broadband (cable) access, frame relay, digital subscriber line (DSL), asynchronous transfer mode (ATM) or other access techniques.

User computing devices 504 preferably have the ability to send and receive data across communication network 506, and are equipped with web browsers, software applications, or other means, to provide received data on display devices incorporated therewith. By way of example, user computing device 504 may be personal computers such as Intel Pentium-class and Intel Core-class computers or Apple Macintosh computers, tablets, smartphones, but are not limited to such computers. Other computing devices which can communicate over a global computer network such as palmtop computers, personal digital assistants (PDAs) and mass-marketed Internet access devices such as WebTV can be used. In addition, the hardware arrangement of the present invention is not limited to devices that are physically wired to communication network 506, and that wireless communication can be provided between wireless devices and information processors 502.

System 500 preferably includes software that provides functionality described in greater detail herein, and preferably resides on one or more information processors 502 and/or user computing devices 504. One of the functions performed by information processor 502 is that of operating as a web server and/or a web site host. Information processors 502 typically communicate with communication network 506 across a permanent i.e., un-switched data connection 508. Permanent connectivity ensures that access to information processors 502 is always available.

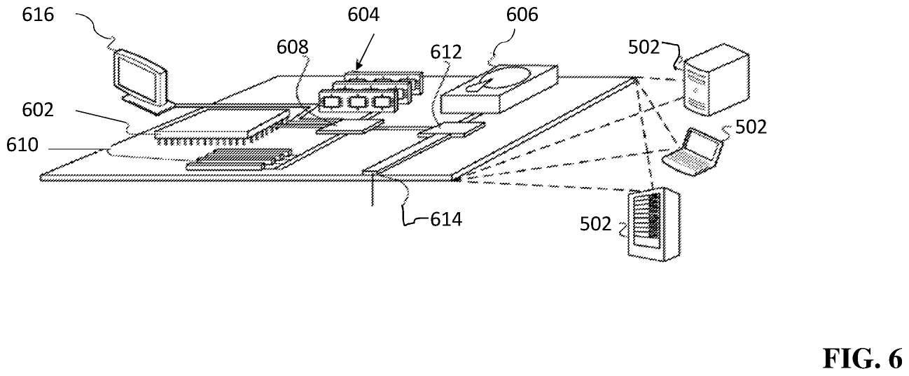

FIG. 6 shows an example information processor 502 that can be used to implement the techniques described herein. The information processor 502 is intended to represent various forms of digital computers, such as laptops, desktops, workstations, personal digital assistants, servers, blade servers, mainframes, and other appropriate computers. The components shown in FIG. 6, including connections and relationships, and their functions, are meant to be exemplary only, and are not meant to limit implementations of the inventions described and/or claimed in this document.

The information processor 502 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and can be mounted on a common motherboard or in other manners as appropriate. The processor 602 can process instructions for execution within the information processor 502, including instructions stored in the memory 604 or on the storage device 606 to display graphical information for a GUI on an external input/output device, such as a display 616 coupled to the high-speed interface 608. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 604 stores information within the information processor 502. In some implementations, the memory 604 is a volatile memory unit or units. In some implementations, the memory 604 is a non-volatile memory unit or units. The memory 604 can also be another form of computer-readable medium, such as a magnetic or optical disk.

The storage device 606 is capable of providing mass storage for the information processor 502. In some implementations, the storage device 606 can be or contain a computer-readable medium, e.g., a computer-readable storage medium such as a floppy disk device, a hard disk device, an optical disk device, or a tape device, a flash memory or other similar solid-state memory device, or an array of devices, including devices in a storage area network or other configurations. A computer program product can also be tangibly embodied in an information carrier. The computer program product can also contain instructions that, when executed, perform one or more methods, such as those described above. The computer program product can also be tangibly embodied in a computer- or machine-readable medium, such as the memory 604, the storage device 606, or memory on the processor 602.

The high-speed interface 608 can be configured to manage bandwidth-intensive operations, while the low-speed interface 612 can be configured to manage lower bandwidth-intensive operations. Of course, one of ordinary skill in the art will recognize that such allocation of functions is exemplary only. In some implementations, the high-speed interface 608 is coupled to the memory 604, the display 616 (e.g., through a graphics processor or accelerator), and to the high-speed expansion ports 610, which can accept various expansion cards (not shown). In an implementation, the low-speed interface 612 is coupled to the storage device 606 and the low-speed expansion port 614. The low-speed expansion port 614, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

As noted herein, the information processor 502 can be implemented in a number of different forms, as shown in the figure. For example, it can be implemented as a standard server, or multiple times in a group of such servers. In addition, it can be implemented in a personal computer such as a laptop computer. It can also be implemented as part of a rack server system. Alternatively, components from the computing device 200 can be combined with other components in a mobile device (not shown), such as a mobile computing device.

The terms “a,” “an,” and “the,” as used in this disclosure, means “one or more,” unless expressly specified otherwise.

The term “communicating device,” as used in this disclosure, means any hardware, firmware, or software that can transmit or receive data packets, instruction signals or data signals over a communication link. The hardware, firmware, or software can include, for example, a telephone, a smart phone, a personal data assistant (PDA), a smart watch, a tablet, a computer, a software defined radio (SDR), or the like, without limitation.

The term “communication link,” as used in this disclosure, means a wired and/or wireless medium that conveys data or information between at least two points. The wired or wireless medium can include, for example, a metallic conductor link, a radio frequency (RF) communication link, an Infrared (IR) communication link, an optical communication link, or the like, without limitation. The RF communication link can include, for example, Wi-Fi, WiMAX, IEEE 802.11, DECT, 0G, 1G, 2G, 3G or 4G cellular standards, Bluetooth, or the like, without limitation.

The terms “computer” or “computing device,” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, a server farm, a computer cloud, or the like, or an array of processors, microprocessors, central processing units, general purpose computers, super computers, personal computers, laptop computers, palmtop computers, notebook computers, desktop computers, workstation computers, servers, or the like, without limitation.

The term “computer-readable medium,” as used in this disclosure, means any storage medium that participates in providing data (for example, instructions) that can be read by a computer. Such a medium can take many forms, including non-volatile media and volatile media. Non-volatile media can include, for example, optical or magnetic disks and other persistent memory. Volatile media can include dynamic random access memory (DRAM). Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium can include a “Cloud,” which includes a distribution of files across multiple (e.g., thousands of) memory caches on multiple (e.g., thousands of) computers.

Various forms of computer readable media can be involved in carrying sequences of instructions to a computer. For example, sequences of instruction (i) can be delivered from a RAM to a processor, (ii) can be carried over a wireless transmission medium, and/or (iii) can be formatted according to numerous formats, standards or protocols, including, for example, Wi-Fi, WiMAX, IEEE 802.11, DECT, 0G, 1G, 2G, 3G, 4G, or 5G cellular standards, Bluetooth, or the like.

The terms “transmission” and “transmit,” as used in this disclosure, refer to the conveyance of signals via electricity, acoustic waves, light waves and other electromagnetic emissions, such as those generated in connection with communications in the radio frequency (RF) or infrared (IR) spectra. Transmission media for such transmissions can include coaxial cables, copper wire and fiber optics, including the wires that comprise a system bus coupled to the processor.

The term “database,” as used in this disclosure, means any combination of software and/or hardware, including at least one application and/or at least one computer. The database can include a structured collection of records or data organized according to a database model, such as, for example, but not limited to at least one of a relational model, a hierarchical model, a network model or the like. The database can include a database management system application (DBMS) as is known in the art. The application may include, but is not limited to, for example, an application program that can accept connections to service requests from clients by sending back responses to the clients. The database can be configured to run the application, often under heavy workloads, unattended, for extended periods of time with minimal human direction.

The terms “including,” “comprising” and variations thereof, as used in this disclosure, mean “including, but not limited to,” unless expressly specified otherwise.

The term “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which can be configured to communicate data via a wireless and/or a wired communication medium. These networks can run a variety of protocols not limited to TCP/IP, IRC or HTTP.

The term “server,” as used in this disclosure, means any combination of software and/or hardware, including at least one application and/or at least one computer to perform services for connected clients as part of a client-server architecture. The server application can include, but is not limited to, for example, an application program that can accept connections to service requests from clients by sending back responses to the clients. The server can be configured to run the application, often under heavy workloads, unattended, for extended periods of time with minimal human direction. The server can include a plurality of computers configured, with the application being divided among the computers depending upon the workload. For example, under light loading, the application can run on a single computer. However, under heavy loading, multiple computers can be required to run the application. The server, or any if its computers, can also be used as a workstation.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

Thus, as shown and described herein, the present disclosure provides a technical solution to augment geographic methodology as part of a security measure to restrict access to corporate secure facilities and/or corporate networks to only authorized entities. The process at least partially includes the ability to configure new security warning criteria for scenarios to flag and report possible security threats. In addition, an advanced geographical or geophysical account locking mechanism can be provided as a function of predefined geophysical zones, which are defined around a most recent secure facility access or network login registered to an entity. Moreover, the present disclosure is applicable to many types existing physical and cybersecurity measures in place for authorizing access to facilities and computing systems. The solutions set forth herein can be particularly useful for such environments that are looking to improve security and handling measures.

The invention encompassed by the present disclosure has been described with reference to the accompanying drawings, which form a part hereof, and which show, by way of illustration, example implementations and/or embodiments. As such, the figures and examples above are not meant to limit the scope of the present application to a single implementation, as other implementations are possible by way of interchange of some or all of the described or illustrated elements, without departing from the spirit of the present disclosure. Among other things, for example, the disclosed subject matter can be embodied as methods, devices, components, or systems.

Moreover, where certain elements of the present application can be partially or fully implemented using known components, only those portions of such known components that are necessary for an understanding of the present application are described, and detailed descriptions of other portions of such known components are omitted so as not to obscure the application. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present application encompasses present and future known equivalents to the known components referred to herein by way of illustration.

Furthermore, it is recognized that terms used herein can have nuanced meanings that are suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter can be based upon combinations of individual example embodiments, or combinations of parts of individual example embodiments.

The foregoing description of the specific implementations will so fully reveal the general nature of the application that others can, by applying knowledge within the skill of the relevant art(s) (including the contents of the documents cited and incorporated by reference herein), readily modify and/or adapt for various applications such specific implementations, without undue experimentation, without departing from the general concept of the present application. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). It is to be understood that dimensions discussed or shown of drawings are shown accordingly to one example and other dimensions can be used without departing from the present disclosure.

While various implementations of the present application have been described above, it should be understood that they have been presented by way of example, and not limitation. It would be apparent to one skilled in the relevant art(s) that various changes in form and detail could be made therein without departing from the spirit and scope of the disclosure. Thus, the present disclosure should not be limited by any of the above-described example implementations, and the invention is to be understood as being defined by the recitations in the claims which follow and structural and functional equivalents of the features and steps in those recitations.

1. A method for regulating access to respective network-based resources by a computing device, the computing device configured to receive information representing access to and/or access requests to resources on at least one network, the method comprising:
detecting, by the computing device, access to a first network-based resource at a first time by a first entity, wherein the first network-based resource and the first entity are represented directly or indirectly by information received by the computing device;
detecting, by the computing device, a request for access to, access to, or both the request for access and access to a second network-based resource at a second time by the first entity, wherein the second network-based resource and the first entity are represented directly or indirectly by information received by the computing device;
calculating, by the computing device, a period of elapsed time between the first time and the second time;
determining, by the computing device, a probability of the first entity accessing or requesting access to the second network-based resource within the period of elapsed time of having accessed the first network-based resource;
identifying, based on the determined probability, by the computing device, a security threat; and
precluding, in response to the identified security threat, by the computing device, the first entity's access to at least one network-based resource.

2. The method of claim 1, further comprising:
determining, by the computing device, a distance between the first network-based resource and the second network-based resource, and
wherein the determined probability is further based on the determined distance.

3. The method of claim 1, further comprising:
determining, by the computing device, a distance from a location of accessing the first network-based resource to a location of accessing and/or requesting access to the second network-based resource, and
wherein the determined probability is further based on the determined distance.

4. The method of claim 1, further comprising:
defining, by the computing device, a plurality of geographic zones, each geographic zone comprising at least one endpoint for at least one respective network-based resource;
determining, by the computing device, a distance between the first network-based resource and the second network-based resource as a function of at least one of the respective geographic zones, and
wherein the determined probability is further based on the determined distance.

5. The method of claim 1, wherein regulating the first entity's access to the at least one network-based resource is based on a change in the first entity's position over time.

6. The method of claim 1, further comprising:
providing to an information security dashboard, by the computing device, information representing the regulation of the first entity's access to at least one network-based resource.

7. The method of claim 6, wherein the information security dashboard includes a graphical user interface having at least one graphical control that, when selected, causes the computing device to regulate the first entity's access to at least one network-based resource.

8. The method of claim 1, wherein the first network-based resource and the second network-based resource are respectively located on at least one physical and/or virtual network.

9. The method of claim 1, wherein accessing the first network-based resource by the first entity physically occurs by scanning an identification card, and wherein accessing or requesting access to the second network-based resource by the first entity occurs by logging into a computing device physically located away from the first network-based resource.

10. The method of claim 1, wherein regulating the first entity's access to at least one network-based resource comprises permitting the first entity's access to at least one resource when the determined probability is inside the predetermined threshold and restricting the first entity's access to at least one resource when the determined probability is outside the predetermined threshold.

11. The method of claim 1, wherein regulating the first entity's access comprises not impeding the first entity's access to at least one network-based resource.

12. The method of claim 1, wherein at least one network-based resource is the second network-based resource.

13. The method of claim 1, wherein the first network-based resource and the second network-based resource are separated by a distance.

14. The method of claim 1, wherein regulating the first entity's access to at least one network-based resource includes downgrading access privileges.

15. The method of claim 1, wherein the access to first network-based resource or second network-based resource occurs via at least one respective endpoint.

16. A system for regulating access to respective network-based resources, the system comprising:
a computing device having access to instructions on non-transitory processor readable media that, when executed by the computing device, configure the computing device to:
receive information representing access to and/or access requests to resources on at least one network;
detect access to a first network-based resource at a first time by a first entity, wherein the first network-based resource and the first entity are represented directly or indirectly by information received by the computing device;
detect a request for access to, access to, or both the request for access and access to a second network-based resource at a second time by the first entity, wherein the second network-based resource and the first entity are represented directly or indirectly by information received by the computing device;
calculate a period of elapsed time between the first time and the second time;
determine a probability of the first entity accessing or requesting access to the second network-based resource within the period of elapsed time of having accessed the first network-based resource;
identify, based on the determined probability, a security threat; and
preclude, in response to the identified security threat, the first entity's access to at least one network-based resource.

17. The system of claim 16, wherein the computing device is further configured to:
determine a distance between the first network-based resource and the second network-based resource,
wherein the determined probability is further based on the determined distance.

18. The system of claim 16, wherein the computing device is further configured to:
determine a distance from a location of accessing the first network-based resource to a location of accessing and/or requesting access to the second network-based resource,
wherein the determined probability is further based on the determined distance.

19. The system of claim 16, wherein the computing device is further configured to:
define a plurality of geographic zones, each geographic zone comprising at least one endpoint for at least one respective network-based resource;
determine a distance between the first network-based resource and the second network-based resource as a function of at least one of the respective geographic zones,
wherein the determined probability is further based on the determined distance.

20. The system of claim 16, wherein regulating the first entity's access to the at least one network-based resource is based on a change in the first entity's position over time.

21. The system of claim 16, wherein the computing device is further configured to:
provide to an information security dashboard information representing the regulation of the first entity's access to at least one network-based resource.

22. The system of claim 21, wherein the information security dashboard includes a graphical user interface having at least one graphical control that, when selected, causes the computing device to regulate the first entity's access to at least one network-based resource.

23. The system of claim 16, wherein regulating the first entity's access to at least one network-based resource comprises permitting the first entity's access to at least one resource when the determined probability is inside the predetermined threshold and restricting the first entity's access to at least one resource when the determined probability is outside the predetermined threshold.

24. A method for regulating access to respective network-based resources by at least one computing device, each such computing device configured to receive information representing access to and/or access requests to resources on at least one network, the method comprising:
detecting electronic access to a first network-based resource at a first time by a first entity, wherein the first network-based resource and the first entity are represented directly or indirectly by information received by the computing device;
detecting a request for access to, access to, or both the request for access and access to a second network-based resource at a second time by the first entity, wherein the second network-based resource and the first entity are represented directly or indirectly by information received by at least one computing device;
calculating, at any of the computing device(s), a period of elapsed time between the first time and the second time;
determining, at any of the computing device(s), a probability of the first entity accessing or requesting access to the second network-based resource within the period of elapsed time of having accessed the first network-based resource;
identifying, based on the determined probability, a security threat; and
precluding, in response to the identified security threat, the first entity's access to at least one network-based resource.

25. The method of claim 24, further comprising:
determining, at any of the computing device(s), a distance between the first network-based resource and the second network-based resource, and
wherein the determined probability is further based on the determined distance.

26. The method of claim 24, further comprising:
determining, at any of the computing device(s), a distance from a location of accessing the first network-based resource to a location of accessing and/or requesting access to the second network-based resource, and
wherein the determined probability is further based on the determined distance.

27. The method of claim 24, further comprising:
defining, at any of the computing device(s), a plurality of geographic zones, each geographic zone comprising at least one endpoint for at least one respective network-based resource;
determining, at any of the computing device(s), a distance between the first network-based resource and the second network-based resource as a function of at least one of the respective geographic zones, and
wherein the determined probability is further based on the determined distance.
